(19) United States
(12) Patent Application Publication
(10) Pub. No.: US 2017/0271047 A1
(43) Pub. Date: Sep. 21, 2017

(54) SHIELDED CONDUCTOR

(71) Applicant: Sumitomo Wiring Systems, Ltd., Yokkaichi (JP)

(72) Inventors: Yuji TANAKA, Yokkaichi (JP); Masanori KUWAHARA, Yokkaichi (JP)

(21) Appl. No.: 15/454,804

(22) Filed: Mar. 9, 2017

(30) Foreign Application Priority Data
Mar. 18, 2016 (JP) 2016054905

(51) Int. Cl. H01B 7/20; H02G 3/04; H01R 4/60

(52) U.S. Cl. CPC H01B 7/20; H01R 4/60; H02G 3/0462

(57) ABSTRACT

A shielded conductor that prevents electrical corrosion from occurring in braided wires and a shield pipe. Separate from a shield pipe that is made of aluminium, a sub pipe that is tin-plated is provided, and an end-portion braided member that is tin-plated is connected to the sub pipe. The shield pipe and the sub pipe are connected by a braided relay member, and the connection portions between the pipes and the braided relay member are accommodated in a grommet in a state of being sealed. A rubber stopper for sealing a space between the sub pipe and the electrical wires (W) is fitted into the sub pipe.

This Application claims the benefit of Japanese Application No. JP2016-054905, filed on Mar. 18, 2016, the contents of which are hereby incorporated by reference in their entirety.

### FIELD

The present invention relates to a shielded conductor.

### BACKGROUND

JP 2004-171952A discloses a shielded conductor that includes a metal shield pipe, and braided members that are provided at both end portions of the shield pipe, and that are obtained by braiding metal bare wires into a tube. By inserting a plurality of electrical wires into the shielded conductor, it is possible to shield the electrical wires altogether.

### SUMMARY

The shield pipe and the braided members are connected by being crimped by crimp rings that are made of metal. Here, the shield pipe and the braided members have different purposes and usages, and thus it is typical that the shield pipe and the braided members are made of different types of metal materials depending on the purposes and usages. Therefore, there is the problem that if the connection portions come into contact with water, electrical corrosion may occur and the connection portions may corrode. In order to avoid this problem, it is conceivable that the connection portions are covered and sealed with grommets that are made of rubber. However, even by using the grommets, it may not always be easy to realize a configuration for ensuring the sealed state, because, for example, it is not possible to ensure the sealed state by sealing the connection portions with the grommets over the braided members.

The present design was made in view of the above-described circumstances, and it is an object to provide a shielded conductor that prevents electrical corrosion of braided wires and a shield pipe.

According to the present design, a shielded conductor includes: a shield pipe; a sub pipe whose one end is connected to an end portion of the shield pipe in a state in which the sub pipe and the shield pipe are conductively connected to each other; a braided member that is obtained by braiding metal bare wires into a tube, and whose one end portion is connected to an outer circumferential surface of the other end of the sub pipe; electrical wires that pass through the shield pipe, the sub pipe, and the braided member; and a grommet whose end portions are in sealing contact with outer circumferential surfaces of the sub pipe and the shield pipe, thus sealing electrical connection regions where the grommet is connected to the shield pipe and the sub pipe, wherein a difference in ionization tendency between the sub pipe and the braided member is smaller than a difference in ionization tendency between the shield pipe and the braided member.

According to the present design, the sub pipe is provided separately from the shield pipe, and the braided member is connected to the sub pipe. The shield pipe constitutes the main portion of the shielded conductor, and thus is subjected to restrictions in material in view of its purpose. Accordingly, if the braided member is directly connected to the shield pipe, it may be difficult to avoid an increase in the difference in ionization tendency between the shield pipe and the braided member. However, the sub pipe is not subjected to such restrictions, and thus a material that reduces the difference in ionization tendency between the sub pipe and the braided member can be selected. Accordingly, by connecting the braided member to the sub pipe, it is possible to effectively reduce a degree of risk for electrical corrosion compared to a case where the braided member is connected to the shield pipe.

On the other hand, a difference in ionization tendency between the shield pipe and the sub pipe is relatively large, since the sub pipe has an ionization tendency that is close to that of the braided member. However, in a part in which the sub pipe and the shield pipe are electrically connected to each other, both end portions of the grommet are in sealing contact with the outer circumferential surfaces of the sub pipe and the shield pipe, so as to stop the entry of water and thus prevent electrical corrosion from occurring.

Hereinafter, preferred embodiments will be described.

Preferably, the shielded conductor has a configuration in which metallization layers that are made of nickel or zinc are applied to the sub pipe and bare wires of the braided member. With such a configuration, the sub pipe and the braided member of the same material are connected to each other, and thus it is possible to reliably prevent electrical corrosion.

Furthermore, preferably, the shield pipe and the sub pipe are connected to each other by a braided relay member that is made of braided wires. With such a configuration, it is possible to electrically connect the shield pipe and the sub pipe using connection means that is a simple braided member.

Furthermore, preferably, a rubber stopper for sealing a space between the sub pipe and the electrical wires is fitted into the sub pipe. With this measure, the rubber stopper can be used to block off an immersion path in which water flows from the mesh of the braided member, passes through the inside of the sub pipe, and reaches a part at which the sub pipe and the shield pipe are electrically connected to each other. Accordingly, it is possible to prevent electrical corrosion from occurring due to the immersion path.

Preferably, the shielded conductor is installed in a vehicle, and the sub pipe is arranged in a submerging region, which is located under the floor of the vehicle. With this measure, even if the sub pipe is arranged in the region where it is to be submerged (under the floor of the vehicle), a risk of electrical corrosion is eliminated, and thus the arrangement of the sub pipe is not restricted, making it possible to effectively attain certain advantages.

### DRAWINGS

FIG. 1 is a diagram schematically illustrating a situation in which a shielded conductor is installed on a vehicle, according to Embodiment 1;

FIG. 2 is a side cross-sectional view illustrating a connection portion of a shield pipe and a braided member, according to Embodiment 1;

FIG. 3 is a cross-sectional view taken along a line A-A of FIG. 2;

FIG. 4 is a cross-sectional view taken along a line B-B of FIG. 2; and

FIG. 5 is a side cross-sectional view illustrating a connection portion of a shield pipe and a braided member, according to Embodiment 2.

### DESCRIPTION

The following will describe Embodiments 1 and 2 into which the shielded conductor is implemented with reference to the drawings.

### Embodiment 1

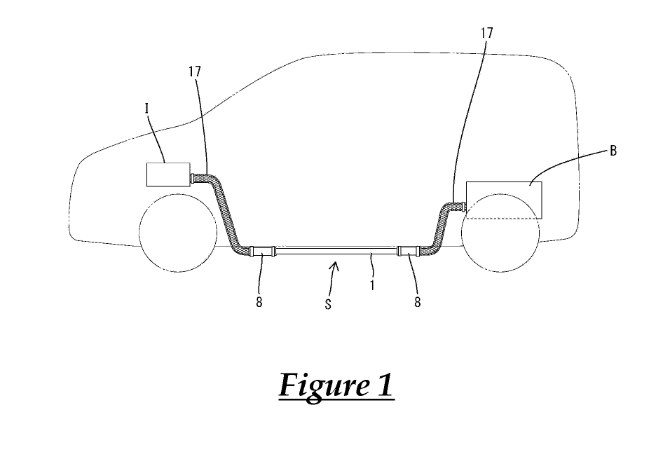

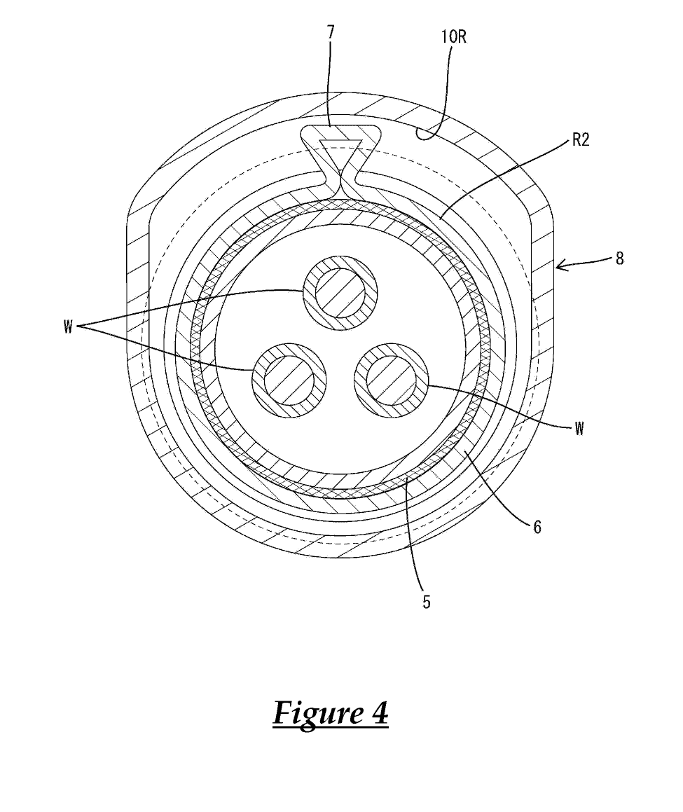

FIGS. 1 to 4 show Embodiment 1. As shown in FIG. 1, a shielded conductor S according to Embodiment 1 is applied to a vehicle such as an electric car or a hybrid car, and connects a battery B installed in the rear portion of the vehicle to an inverter I installed in an engine room.

The shielded conductor S of Embodiment 1 includes a shield pipe 1 into which three electrical wires W (non-shield electrical wires) are inserted. The shield pipe 1 is made of metal (for example, aluminium or an aluminium alloy), and employs an elongated cylindrical pipe. As shown in FIG. 1, the shield pipe 1 is arranged under the floor of the vehicle in an approximately front-rear direction. The shield pipe 1 is appropriately bent midway in a length direction, and both front and rear end portions thereof are raised upward.

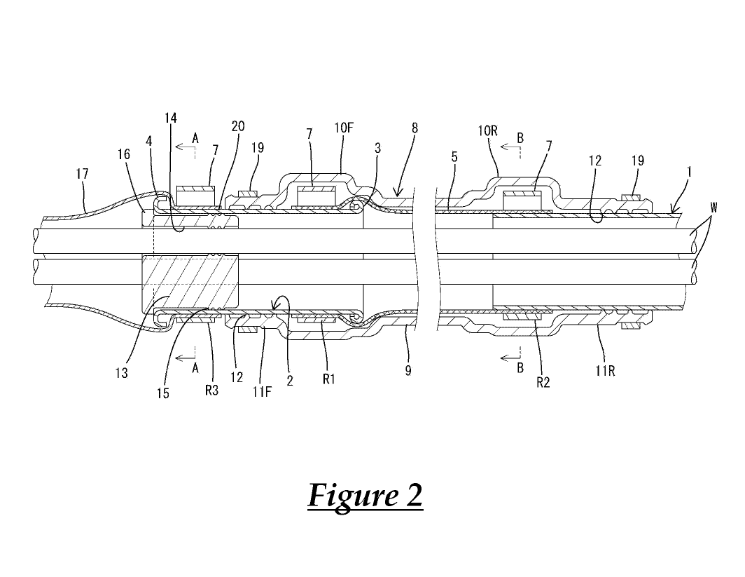

The electrical wires W that are inserted into the shield pipe 1 are drawn out from both the end portions of the shield pipe 1, and end portions of the electrical wires W are electrically connected to the battery B, the inverter I, and the like. FIG. 2 shows a structure of the front end (where the end portion is connected to the inverter I) of the shielded conductor S of Embodiment 1.

As shown in FIG. 2, in Embodiment 1, the shield pipe 1 is connected to braided members (end-portion braided members 17) not directly but via sub pipes 2 that are provided separately from the shield pipe 1. Furthermore, as shown in FIG. 1, the entirety of the shield pipe 1, and the sub pipes 2 that are arranged in the front and rear end portions of the shield pipe 1 are arranged under the floor of the vehicle, that is, in a submerging region. In the shielded conductor S, the end-portion braided members 17 connected to the sub pipes 2 extend from the sub pipes 2, and then are raised to enter an engine room or the interior of the vehicle, which is located above the floor of the vehicle (non-submerging region).

The sub pipes 2 are made of a pipe material that is shorter than the shield pipe 1. Each sub pipe 2 has a base that is made of, for example, iron, and has a surface to which a metallization layer is applied by tin-plating (or, alternatively, zinc-plating). The sub pipe 2 has substantially the same inner and outer diameters as those of the shield pipe 1. One end edge (right end edge of FIG. 2) of the sub pipe 2 is folded back to the outer surface side over its entire circumference, forming a curl portion 3. The other end edge (left end edge of FIG. 2) of the sub pipe 2 is folded back to the outer surface side over the entire circumference in the shape of a semicircle in cross-section, forming a displacement prevention portion 4.

The sub pipe 2 and the shield pipe 1 are connected to each other by a braided relay member 5. The braided relay member 5 is braided into a tube-shaped mesh with a plurality of metal bare wires. In Embodiment 1, copper wires whose surfaces are tin-plated are used as the metal bare wires.

One end of the braided relay member 5 is fitted to the outer circumferential surface of the front end portion of the shield pipe 1, and the other end of the braided relay member 5 extends over the curl portion 3 and is fitted to the outer circumferential surface of the rear end portion of the sub pipe 2. These fitted portions of the braided relay member 5 are fixed to the respective pipes 1 and 2 by being crimped by crimp rings R1 and R2.

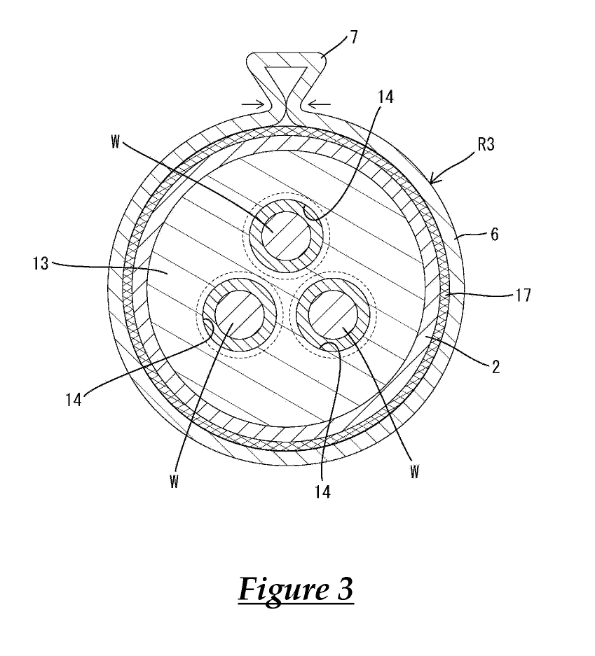

The crimp rings R1 and R2 are made of stainless steel, and each have a shape in which a protrusion-shaped crimping portion 7 protrudes outward in a radial direction from a ring-shaped main portion 6. The root portions of the crimping portion 7 before crimping are separated from each other, but by squeezing and deforming the crimping portion 7 so that the root portions approach each other in the direction shown in FIG. 3, the diameter of the main portion 6 is reduced. Thus, it is possible to connect and fix the braided relay member 5 to both the pipes 1 and 2. Note that the above-described curl portion 3 of the sub pipe 2 prevents the crimp ring R1 from being removed.

As shown in FIG. 2, the connection portions of the braided relay member 5 to the shield pipe 1 and the sub pipe 2 remain water-tight due to a grommet 8. The grommet 8 is made of a rubber, and has favorable flexibility. The grommet 8 as a whole is substantially cylindrical, and can be penetrated by the shield pipe 1 and the sub pipe 2.

The grommet 8 includes a base portion 9 in an intermediate portion in its axial direction, and a pair of front and rear ring accommodating portions 10F and 10R that are formed continuously from the front and rear sides of the base portion 9, and in which the respective crimp rings R1 and R2 can be accommodated. The ring accommodating portions 10F and 10R are partial areas, in a circumferential direction, of the grommet 8 that largely expand outward in the radial direction, and are formed so as to be able to accommodate the crimp rings R1 and R2 without interfering with the crimping portions 7 thereof.

In the grommet 8, a pair of tubular sealing portions 11F and 11R respectively extend coaxially frontward and rearward in the axial direction from the ring accommodating portions 10F and 10R. The tubular sealing portions 11F and 11R are cylindrical. Note that end portions of the braided relay member 5 do not substantially overlap with the respective tubular sealing portions 11F and 11R.

A plurality of sealing lips 12 are provided on the inner circumferential surfaces of the tubular sealing portions 11F and 11R over the entire circumference, and are in intimate contact with the outer circumferential surfaces of the shield pipe 1 and the sub pipe 2, sealing them. Accordingly, it is possible to prevent water from entering the grommet 8 from its end portions. In FIG. 2, a fastening band 19 is fastened on the outer circumferential surfaces of the tubular sealing portions 11F and 11R so as to prevent the tubular sealing portions 11F and 11R from expanding and deforming on the open ends.

Furthermore, a rubber stopper 13 is fitted to the front end of the sub pipe 2 while being pressed into the sub pipe 2. Furthermore, a plurality of sealing edges 20 protrude from the outer circumferential surface of the front end portion of the rubber stopper 13 in the insertion direction, and are in intimate contact with the inner circumferential surface of the sub pipe 2 in a state of sealing it. The rubber stopper 13 is provided with electrical-wire through holes 14 into each of which an electrical wire W can be inserted, and that penetrate the rubber stopper 13 in the axial direction. Each electrical-wire through hole 14 is provided with, on the inner circumferential surface thereof, a plurality of sealing projection edges 15 that project therefrom over the entire circumference, and the electrical wire W is inserted through the electrical-wire through hole 14 in a state of being sealed. The front end portion of the rubber stopper 13 is provided with a flange edge 16 that protrudes outward in the radial direction over the entire circumference, and can abut against the front end edge of the sub pipe 2.

The rear end portion of the end-portion braided member 17 is fitted to the outer circumferential surface of the front end portion of the sub pipe 2. The front end of the end-portion braided member 17 extends to the inverter I. The end-portion braided member 17 is made of the same material as the braided relay member 5, and is tin-plated (or zinc-plated), like the braided relay member 5. The end-portion braided member 17 has favorable flexibility, like the braided relay member 5.

The end-portion braided member 17 that is fitted to the front end portion of the sub pipe 2 is crimped by a crimp ring R3, and is fixed to the sub pipe 2. This crimp ring R3 has the same configuration as the above-described crimp ring R1 that fixes the braided relay member 5, and is prevented from being removed by the displacement prevention portion 4.

Note that the rear end of the shield pipe 1 is also configured to be shielded using a sub pipe 2 as described above. If the rear end of the shield pipe 1 is in an environment in which it does not need to be shielded, the end-portion braided member 17 may also be directly connected to the rear end portion of the shield pipe 1.

The following will describe functions and effects of Embodiment 1 having the above-described configuration. Also in Embodiment 1, the shield pipe 1 is required to be light-weight, have superior conductivity, and be easily subjected to bending, for example, and thus employs a shield pipe made of aluminium or an alloy thereof. If a braided member (end-portion braided member 17) that is tin-plated is directly applied to such a shield pipe 1 as in the conventional case, the difference in ionization tendency may be large and there is a risk that electrical corrosion may occur.

In view of this view point, in Embodiment 1, the end-portion braided member 17 is directly connected to the sub pipe 2, which is separate from the shield pipe 1, and the metallization layer that is applied to the sub pipe 2 and the metallization layer that is applied to the end-portion braided member are made of the same material (tin). Accordingly, even if the connection portion of the end-portion braided member 17 and the sub pipe 2 is directly exposed to water, the risk that electrical corrosion may occur is eliminated. Note that it is known that applying a tin plate to the shield pipe 1 made of aluminium lacks reliability with respect to adhesiveness, corrosion resistance, and the like, and plating it is difficult.

As described above, in the present embodiment, since the sub pipe 2 is provided separately from the shield pipe 1, the sub pipes 1 and 2 are connected to each other by the braided relay member 5 so as to be electrically conductive. In addition thereto, since the sub pipe 2 is connected to the end-portion braided member 17, it is possible to shield the electrical wires W over their entire length.

Preventing electrical corrosion from occurring in the connection portion of the shield pipe 1 made of aluminium and the braided relay member 5 is realized by the grommet 8 and the rubber stopper 13. In other words, since the tubular sealing portions 11F and 11R of the grommet 8 are respectively in intimate contact with the outer circumferential surfaces of the shield pipe 1 and the sub pipe 2 so as to be water-tight, that is, since the grommet 8 can directly come into intimate contact with the outer circumferential surface of the shield pipe 1 or the sub pipe 2 without the braided member interposed therebetween, it is possible to reliably block off an immersion path in which water flows from a space between the tubular sealing portion 11F and the sub pipe 2, or the tubular sealing portion 11R and the shield pipe 1.

On the other hand, an immersion path in which water flows from the mesh of the end-portion braided member 17, and passes through the sub pipe 2 and the grommet 8 is blocked off by the rubber stopper 13 that closes the front end portion of the sub pipe 2. Accordingly, both the above-described immersion paths can be reliably blocked off, and thus it is possible to reliably prevent electrical corrosion from occurring in the space between the shield pipe 1 and the braided relay member 5.

### Embodiment 2

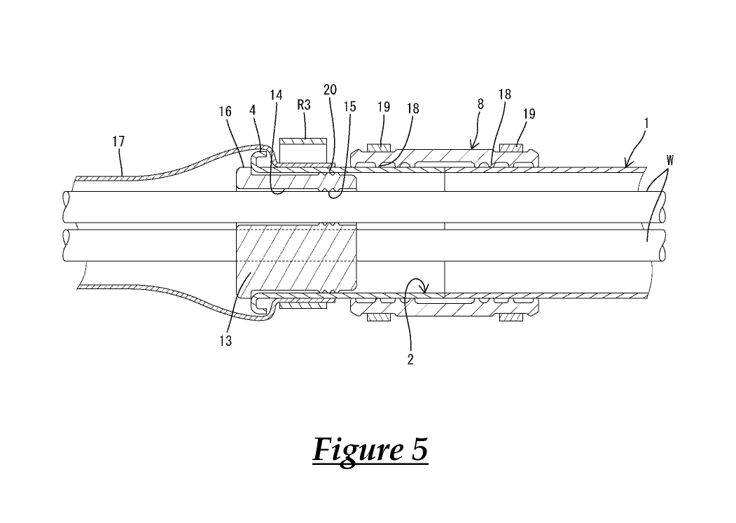

FIG. 5 shows Embodiment 2 of the present invention. In Embodiment 1, the braided relay member 5 is used as a means for electrically connecting the shield pipe 1 and the sub pipe 2. In Embodiment 2, the pipes 1 and 2 are directly connected to each other by welding or the like. Also in this case, it is necessary to prevent electrical corrosion from occurring in the connection portion of the pipes 1 and 2. Accordingly, in Embodiment 2, a cylindrical grommet 8 is (or a heat shrinkable tube may be) fitted to the pipes, spanning them. The grommet 8 that is used here is provided with sealing edges 18 on the inner circumferential surfaces of both end portions of the grommet 8. Other structural aspects are the same as those of Embodiment 1.

Also in Embodiment 2 having the configuration above, it is possible to achieve the same functions and effects as those of Embodiment 1.

### Other Embodiments

The present invention is not limited to the embodiments described in the above description and the drawings, and the technical scope of the present invention include, for example, the following embodiments:

The foregoing embodiments relate to a configuration in which the connection portion between the sub pipe 2 and the end-portion braided member 17 is exposed to the outside, but a configuration is also possible in which the connection portion is enclosed by an exterior material such as a corrugated tube.

In the foregoing embodiments, the braided members 5 and 17 and the pipes 1 and 2 are connected by the crimp rings R1 to R3, but the braided members 5 and 17 and the pipes 1 and 2 may also be connected by other fixing means such as welding.

Embodiment 1 relates to a configuration in which the shield pipe 1 and the sub pipe 2 are electrically connected to each other by the braided relay member 5, but they may also be connected to each other by, instead of the braided relay member 5, a tubular member that is made of a conductive resin.

Embodiment 1 relates to a configuration in which the tubular sealing portions 11F and 11R of the grommet 8 are simply fitted to the respective shield pipe 1 and the sub pipe 2, but they may also be wound by tapes over the fitted portions, which makes it possible to further enhance the sealing property.

In Embodiment 1, the sub pipe 2 has a configuration in which the curl portion 3 and the displacement prevention portion 4 are respectively provided in the end portions of the sub pipe 2, but the sub pipe 2 may also have a configuration without these portions.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### REFERENCE SIGNS LIST

1 . . . Shield pipe
2 . . . Sub pipe
5 . . . Braided relay member
8 . . . Grommet
13 . . . Rubber stopper
17 . . . End-portion braided member
S . . . Shielded conductor
W . . . Electrical wire
R1 to R3 . . . Crimp ring

1. A shielded conductor comprising:
a shield pipe;
a sub pipe whose one end is connected to an end portion of the shield pipe in a state in which the sub pipe and the shield pipe are conductively connected to each other;
a braided member that is obtained by braiding metal bare wires into a tube, and whose one end portion is connected to an outer circumferential surface of the other end of the sub pipe;
electrical wires that pass through the shield pipe, the sub pipe, and the braided member; and
a grommet whose end portions are in sealing contact with outer circumferential surfaces of the sub pipe and the shield pipe, thus sealing electrical connection regions where the grommet is connected to the shield pipe and the sub pipe,
wherein a difference in ionization tendency between the sub pipe and the braided member is smaller than a difference in ionization tendency between the shield pipe and the braided member.

2. The shielded conductor according to claim 1,
wherein metallization layers that are made of nickel or zinc are applied to the sub pipe and the bare wires of the braided member.

3. The shielded conductor according to claim 1,
wherein the shield pipe and the sub pipe are connected to each other by a braided relay member that is made of braided wires.

4. The shielded conductor according to claim 1,
wherein a rubber stopper for sealing a space between the sub pipe and the electrical wires is fitted into the sub pipe.

5. The shielded conductor according to claim 1,
wherein the shielded conductor is installed in a vehicle, and
the sub pipe is arranged in a submerging region, which is located under the floor of the vehicle.
